(19) United States
(12) Patent Application Publication
(10) Pub. No.: US 2026/0111755 A1
(43) Pub. Date: Apr. 23, 2026

(54) QUANTIZATION METHOD OF A NEURAL NETWORK MODEL AND ELECTRONIC DEVICE

(71) Applicant: SAMSUNG ELECTRONICS CO., LTD., Suwon-si (KR)

(72) Inventor: Yue Li, Xi'an (CN)

(21) Appl. No.: 18/946,373

(22) Filed: Nov. 13, 2024

(30) Foreign Application Priority Data
Oct. 17, 2024 (CN) 202411457391.X

(51) Int. Cl. G06N 3/0985; G06N 3/0495

(52) U.S. Cl. CPC G06N 3/0985; G06N 3/0495

(57) ABSTRACT

Disclosed are a quantization method of a neural network model and an electronic device. The quantization method comprises: performing quantization on layers in a first neural network model, to obtain a second neural network model; calculating, using the second neural network model as a current neural network model, a layer sensitivity of each layer, on which the quantization has been performed, in the current neural network model; updating the current neural network model by canceling the quantization of a layer, having a highest layer sensitivity, to obtain a third neural network model; calculating, using the third neural network model as the current neural network model, a layer sensitivity of each layer, in the current neural network model; repeating the updating and the calculating until a predetermined number of third neural network models are obtained; and selecting an optimal neural network model.

### CROSS-REFERENCE TO RELATED APPLICATION

This application is based on and claims priority under 35 U.S.C. § 119 to Chinese Patent Application No. 202411457391.X, filed on Oct. 17, 2024, with the China National Intellectual Property Administration, the disclosure of which is incorporated by reference herein in its entirety.

### TECHNICAL FIELD

The disclosure relates to a field of computer technology, and more particularly, to a quantization method of a neural network model and an electronic device.

### BACKGROUND

Neural network models are widely applied to process multimedia data. Quantization (e.g., mixed precision quantization (MPQ)) is one of effective ways of improving performance of neural network models and compressing the size of neural network models. However, selecting a reasonable configuration that enables the neural network model to balance precision and a speed of processing the multimedia data from among configurations of all mixed precision quantization can be time-consuming.

### SUMMARY

The disclosure provides a quantization method of a neural network model and an electronic device. In some implementations, the method efficiently determines the neural network model for processing multimedia data, e.g., by efficiently selecting and evaluating configurations of mixed precision quantization.

In a first general aspect, a quantization method of a neural network model for processing multimedia data includes: performing quantization on a plurality of layers in a first neural network model, to obtain a second neural network model; calculating, using the second neural network model as a current neural network model, a layer sensitivity of each layer of layers, on which the quantization has been performed, in the current neural network model; updating the current neural network model by canceling the quantization of a layer, having a highest layer sensitivity, among the layers on which the quantization has been performed, to obtain a third neural network model; calculating, using the third neural network model as the current neural network model, a layer sensitivity of each layer of layers, on which the quantization has been performed, in the current neural network model; repeating the updating and the calculating until a predetermined number of third neural network models are obtained; and selecting an optimal neural network model from among the predetermined number of third neural network models.

In some implementations, configurations of the mixed precision quantization are found by greedily searching for the layer having the highest layer sensitivity among the layers on which the quantization has been performed and recovering the layer having the highest layer sensitivity, thereby increasing the efficiency of selecting a suitable configuration from among configurations of all mixed precision quantization, to efficiently determine the neural network model for the processing multimedia data.

The canceling may comprise setting weights of the layer having the highest layer sensitivity to weights, previous to the quantization, of the layer having the highest layer sensitivity. The predetermined number may be equal to a number of the plurality of layers.

The calculating the layer sensitivity of each layer of the layers on which the quantization has been performed in the current neural network model may comprise: determining a first layer sensitivity of the layer based on a position of the layer in the current neural network model; determining a second layer sensitivity of the layer based on a rate of change in noise of the layer; and determining the layer sensitivity of the layer based on the first layer sensitivity of the layer and the second layer sensitivity of the layer.

The determining the second layer sensitivity of the layer may comprise: determining an input noise-to-signal ratio of the layer based on an original input and a quantization input of the layer; determining an output noise-to-signal ratio of the layer based on an original output and a quantization output of the layer; and determining the rate of change in noise of the layer, based on the input noise-to-signal ratio and the output noise-to-signal ratio of the layer, wherein the original input of the layer represents an input of a corresponding layer, corresponding to the layer, of the first neural network model obtained by executing the first neural network model, and the quantization input of the layer represents an input of the layer obtained by executing the current neural network model, and wherein the original output of the layer represents an output of the corresponding layer, corresponding to the layer, of the first neural network model obtained by executing the first neural network model, and the quantization output of the layer represents an output of the layer obtained by executing the current neural network model.

The smaller a distance of the layer from an input layer of the current neural network model, the higher the first layer sensitivity of the layer, wherein the first layer sensitivity of the layer is determined based on a range of inverse quantization weights of each layer subsequent to the layer in the current neural network model, and wherein the inverse quantization weights of each layer subsequent to the layer in the current neural network model are based on weights, after the quantization, of each layer subsequent to the layer in the current neural network model.

In some implementations, by determining the layer sensitivity using the first layer sensitivity that reflects influence of the position of the layer and the second layer sensitivity that reflects influence of quantization noise on each layer, the sensitivity of the layer with respect to the quantization can be more effectively measured and a decrease in the precision of the neural network model due to quantization of layers having high sensitivities can be avoided. Accordingly, a configuration of suitable mixed precision quantization can be selected.

The selecting the optimal neural network model may comprise: calculating a loss associated with each of the predetermined number of third neural network models, based on a rate of change in noise of an output layer of each of the predetermined number of third neural network models and a size of each of the predetermined number of third neural network models; and selecting a neural network model having a smallest loss from among the predetermined number of third neural network models

The selecting the optimal neural network model may comprise determining the size of each of the predetermined number of third neural network models, based on a sum of bitwidths of weights of a plurality of layers of each of the predetermined number of third neural network models.

In some implementations, using the rate of change in noise in the output layer of the third neural network model and the size of the third neural network model as indexes for evaluating the third neural network model or the configuration of the mixed precision quantization, reduces a number of multimedia data for the evaluation while maintaining accuracy of the evaluation, which decreases time and power consumption required for the evaluation.

In a second general aspect, an electronic device includes: a quantization module configured to perform quantization on a plurality of layers in a first neural network model, to obtain a second neural network model; an updating module configured to: calculate, using the second neural network model as a current neural network model, a layer sensitivity of each layer of layers, on which the quantization has been performed, in the current neural network model, update the current neural network model by canceling the quantization of a layer, having a highest layer sensitivity, among the layers on which the quantization has been performed, to obtain a third neural network model, calculate, using the third neural network model as the current neural network model, a layer sensitivity of each layer of layers, on which the quantization has been performed, in the current neural network model, and repeat the updating and the calculating until a predetermined number of third neural network models are obtained; and a selection module configured to select an optimal neural network model from among the predetermined number of third neural network models.

In some implementations, configurations of the mixed precision quantization are found by greedily searching for the layer having the highest layer sensitivity among the layers on which the quantization has been performed and recovering the layer having the highest layer sensitivity, thereby increasing the efficiency of selecting a suitable configuration from among configurations of all mixed precision quantization, to efficiently determine the neural network model for the processing multimedia data.

The updating module may be configured to cancel the quantization of the layer having a highest layer sensitivity by setting weights of the layer having the highest layer sensitivity to weights, previous to the quantization, of the layer having the highest layer sensitivity. The predetermined number may be equal to a number of the plurality of layers.

The updating module may be configured to: calculate the layer sensitivity of each layer of the layers on which the quantization has been performed in the current neural network model by: determining a first layer sensitivity of the layer based on a position of the layer in the current neural network model; determining a second layer sensitivity of the layer based on a rate of change in noise of the layer; and determining the layer sensitivity of the layer based on the first layer sensitivity of the layer and the second layer sensitivity of the layer.

The updating module may be configured to: determine an input noise-to-signal ratio of the layer based on an original input and a quantization input of the layer; determine an output noise-to-signal ratio of the layer based on an original output and a quantization output of the layer; and determine the rate of change in noise of the layer, based on the input noise-to-signal ratio and the output noise-to-signal ratio of the layer, wherein the original input of the layer represents an input of a corresponding layer, corresponding to the layer, of the first neural network model obtained by executing the first neural network model, and the quantization input of the layer represents an input of the layer obtained by executing the current neural network model, and wherein the original output of the layer represents an output of the corresponding layer, corresponding to the layer, of the first neural network model obtained by executing the first neural network model, and the quantization output of the layer represents an output of the layer obtained by executing the current neural network model.

The smaller a distance of the layer from an input layer of the current neural network model, the higher the first layer sensitivity of the layer, wherein the first layer sensitivity of the layer is determined based on a range of inverse quantization weights of each layer subsequent to the layer in the current neural network model, and wherein the inverse quantization weights of each layer subsequent to the layer in the current neural network model are based on weights, after the quantization, of each layer subsequent to the layer in the current neural network model.

In some implementations, by determining the layer sensitivity using the first layer sensitivity that reflects influence of the position of the layer and the second layer sensitivity that reflects influence of quantization noise on each layer, the sensitivity of the layer with respect to the quantization can be more effectively measured and a decrease in the precision of the neural network model due to quantization of layers having high sensitivities can be avoided. Thus a configuration of suitable mixed precision quantization can be selected.

The selection module may be configured to: calculate a loss associated with each of the predetermined number of third neural network models, based on a rate of change in noise of an output layer of each of the predetermined number of third neural network models and a size of each of the predetermined number of third neural network models; and select a neural network model having a smallest loss from among the predetermined number of third neural network models.

The selection module may be configured to determine the size of each of the predetermined number of third neural network models, based on a sum of bitwidths of weights of a plurality of layers of each of the predetermined number of third neural network models.

In some implementations, using the rate of change in noise in the output layer of the third neural network model and the size of the third neural network model as indexes for evaluating the third neural network model or the configuration of the mixed precision quantization, reduces a number of multimedia data for the evaluation while maintaining accuracy of the evaluation, which decreases time and power consumption required for the evaluation.

In a third general aspect, a computer-readable storage medium storing a computer program that, when executed by a processor, implemented the above quantization method.

### BRIEF DESCRIPTION OF THE DRAWINGS

FIG. 1 is a diagram illustrating an example of a neural network model.

FIG. 2 is a flowchart illustrating an example of a quantization method of a neural network model.

FIG. 3 is a flowchart illustrating an example of a process of determining a layer sensitivity.

FIG. 4 is a flowchart illustrating an example of a quantization method of a neural network model.

FIG. 5 is a block diagram illustrating an example of an electronic device.

### DETAILED DESCRIPTION

Various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples, and the examples may be implemented in various forms. The examples are not meant to be limited, but various modifications, equivalents, and alternatives are also supported within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

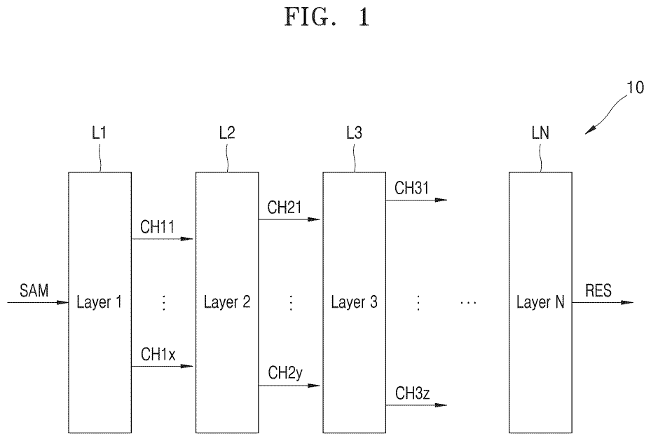

FIG. 1 is a diagram illustrating an example of a neural network model.

For example, FIG. 1 is a diagram schematically showing the structure of a deep neural network (DNN) 10 as an example of a neural network model.

The neural network model may refer to a computing system focused on a biological neural network constituting an animal brain. The neural network model may be trained to perform tasks by considering multiple samples (or examples), unlike classical algorithms that perform tasks according to predefined conditions, such as rule-based programming. The neural network model may have a structure in which artificial neurons (or neurons) are connected, and a connection between neurons may be referred to as a synapse. A neuron may process received signals and transmit the processed signals to another neuron through the synapse. The output of the neuron may be referred to as “activation”. The neuron and/or synapse may have a variable weight, and the influence of the signal processed by the neuron may increase or decrease depending on the weight. In particular, the weight associated with an individual neuron may be referred to as a bias.

A deep neural network (DNN) or a deep learning architecture may have a layer structure, and output of a specific layer may be an input of a subsequent layer. In such a multi-layered structure, each of the layers may be trained according to multiple samples. The neural network model, such as DNN may be implemented by a number of processing nodes corresponding to neurons respectively, which may require higher computational complexity so as to obtain good results, such as higher accuracy results, and, accordingly, many computing resources may be required.

Referring to FIG. 1, a DNN 10 may include a plurality of layers L1, L2, L3, . . . , LN (e.g., N may be an integer greater than 3), and the output of a layer may be input to a subsequent layer through at least one channel. For example, the first layer L1 may provide an output to the second layer L2 through a plurality of channels CH11 . . . CH1x by processing a sample SAM, and the second layer L2 may also provide an output to the third layer L3 through a plurality of channels CH21 . . . CH2y. Finally, the Nth layer LN may output a result RES, and the result RES may include at least one value related to the sample SAM. The number of channels through which the outputs of the plurality of layers L1, L2, L3, . . . , LN are transferred may be the same or different. For example, the number of channels CH21 . . . CH2y of the second layer L2 and the number of channels CH31 . . . CH3z of the third rater L3 may be the same or different. For example, x, y, and z may be integers greater than 1.

The sample SAM may be input data processed by the DNN 10. For example, the sample SAM may include multimedia data (e.g., but not limited to, image data, speech data, text data, and so on).

The DNN 10 may include a large number of layers or channels, and accordingly, the computational complexity of the DNN 10 may increase. The DNN 10 with high computational complexity may require a lot of resources. Therefore, in order to reduce the computational complexity of the DNN 10, the DNN 10 may be quantized. Quantization of the DNN 10 may refer to a process of mapping input values to values with a number smaller than the number of the input values, such as mapping a real number to an integer through rounding. The quantized DNN 10 may have low computational complexity but may have reduced accuracy due to an error occurring in the quantization process.

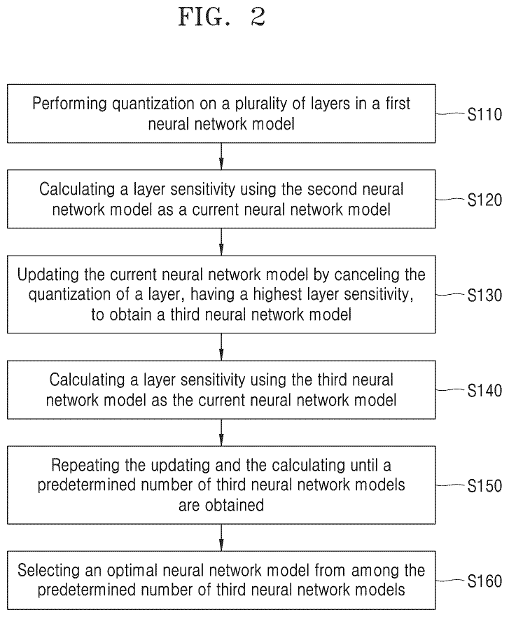

FIG. 2 is a flowchart illustrating an example of a quantization method of a neural network model.

As shown in FIG. 2, in step S110, quantization may be performed on a plurality of layers in a first neural network model, to obtain a second neural network model. The second neural network includes layers on which the quantization has been performed.

In some implementations, the first neural network model may be a high-precision model and the second neural network model may be a low-precision model. For example, each layer (e.g., weights of each layer) in the first neural network model may have a first bitwidth, each layer (e.g., weights of each layer) in the second neural network model may have a second bitwidth, and the first bitwidth may be greater than the second bitwidth.

In step S120, a layer sensitivity of each layer of layers, on which the quantization has been performed, in a current neural network model may be calculated, using the second neural network model as the current neural network model. In this specification, a current neural network refers to a neural network model that is updated at a present time or at a preset step, in the process of updating the first neural network model.

In some implementations, a layer sensitivity of a layer on which the quantization has been performed may represent influence of the quantization on precision of the layer. For example, whether or not to cancel the quantization of the layer may be determined based on the layer sensitivity of the layer on which the quantization has been performed. For example, the higher the layer sensitivity of the layer (e.g., the greater the influence of the quantization on the precision of the layer), the higher a probability that the quantization of the layer is canceled (e.g., the lower a probability that the layer is quantized in an optimal neural network model (to be described later) is).

In an example, the layer sensitivity of the layer on which the quantization has been performed may be determined based on a first layer sensitivity and/or a second layer sensitivity (which will be described later) of the layer on which the quantization has been performed.

In an example, the first layer sensitivity of the layer on which the quantization has been performed may be based on a position of the layer on which the quantization has been performed, in the current neural network model.

In an example, the current neural network model and the first neural network model may be executed with predetermined input data, and the second layer sensitivity of the layer, on which the quantization has been performed, in the current neural network model is determined based on results of executing the current neural network model and the first neural network model. For example, the second layer sensitivity of the layer on which the quantization has been performed may be determined based on an input and an output of the layer, on which the quantization has been performed, in the current neural network model obtained after executing the current neural network model, and an input and an output of a layer, corresponding to the layer on which the quantization has been performed, in the first neural network model obtained after executing the first neural network model. For example, the predetermined input data may be multimedia data.

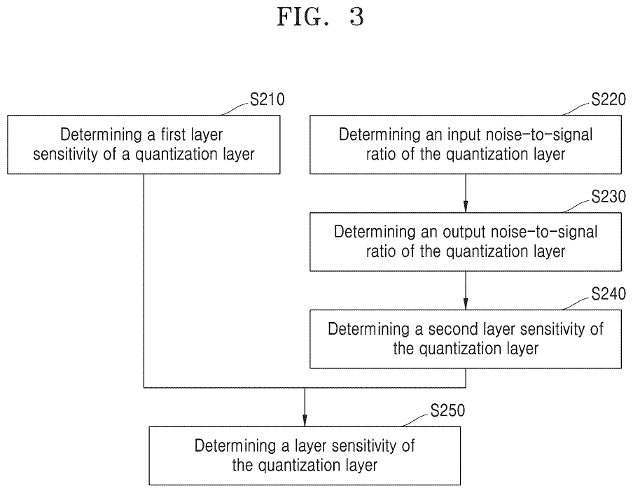

Hereinafter, processing a determination of the layer sensitivity will be described in detail with reference to FIG. 3.

In step S130, the current neural network model may be updated by canceling the quantization of a layer having a highest layer sensitivity among the layers on which the quantization has been performed, to obtain a third neural network model.

In some implementations, a greedy search algorithm may be used to search for the layer having the highest layer sensitivity from among the layers on which the quantization has been performed to improve the efficiency of searching.

In some implementations, the quantization of the layer having the highest layer sensitivity may be canceled by setting weights of the layer having the highest layer sensitivity to the weights (e.g., weights of a layer, corresponding to the layer having the highest layer sensitivity, of the first neural network model), prior to the quantization, e.g., before step S110, of the layer having the highest layer sensitivity. In other words, the weights of the layer having the highest layer sensitivity before quantization are equal to a first set of values, and the weights of the layer having the highest layer sensitivity after quantization are equal to a second set of values. The quantization may be canceled by changing the second set of values back to the first set of values.

In step S140, a layer sensitivity of each layer of layers, on which the quantization has been performed, in the current neural network model may be calculated, using the third neural network model as the current neural network model.

After step S150, the process may return to the step S130, to repeat the updating the current neural network model and the calculating the layer sensitivity until a predetermined number of the third neural network model is obtained.

In some implementations, the predetermined number may be equal to a number of the plurality of layers in the first neural network model. In other words, the above steps S130 and S140 may be repeated until the quantization of all layers in the second neural network model is canceled.

In step S160, an optimal neural network model may be selected from among the predetermined number of third neural network models.

In some implementations, a loss associated with the third neural network model may be determined based on precision and a size of the third neural network model. For example, the precision of the third neural network model may be expressed as a rate of change in noise of an output layer of the third neural network model (which will be described in detail below with reference to FIG. 3), and the size of the third neural network model may be expressed as a sum of bitwidths of the weights of a plurality of layers in the third neural network model.

In an example, the loss associated with the third neural network model may be determined by the following Equation (1).

loss(c)=NSR(last_layer;c)+λ*model_size(c) Equation (1)

In Equation (1), loss(c) may denote a loss associated with a third neural network model c, NSR(last_layer; c) may denote a rate of change in noise of an output layer in the third neural network model c, model_size(c) may denote a size of the third neural network model c, and k is a predetermined value.

In an example, after determining the optimal neural network model, a configuration (including a bitwidth of weights of each layer included in the optimal neural network model) of mixed precision quantization corresponding to the optimal neural network model may be determined.

In some implementations, configurations of the mixed precision quantization are found by greedily searching for the layer having the highest layer sensitivity among the layers on which the quantization has been performed and recovering the layer having the highest layer sensitivity, thereby increasing the efficiency of selecting a suitable configuration from among configurations of all mixed precision quantization.

Compared to a traditional way of evaluating the neural network model using a large amount of multimedia data (e.g., tens of thousands of images), the present disclosure uses the rate of change in noise in the output layer of the third neural network model and the size of the third neural network model as indexes for evaluating the third neural network model or the configuration of the mixed precision quantization. As a result, only several multimedia data (e.g., tens of images) may be used to evaluate the third neural network model, and thus, an amount of the multimedia data for the evaluation can be effectively reduced while maintaining accuracy of the evaluation, which decreases time and power consumption required for the evaluation.

FIG. 3 is a flowchart illustrating an example of a process of determining a layer sensitivity.

As shown in FIG. 3, in step S210, a first layer sensitivity of a layer (hereinafter, referred to as a quantized layer or a quantization layer), on which quantization has been performed, in a current neural network model may be determined based on a position of the quantization layer in the current neural network model.

In some implementations, the smaller a distance of the quantization layer in the current neural network model from an input layer of the current neural network model, the higher the first layer sensitivity of the quantization layer. For example, the distance of the quantization layer in the current neural network model from an input layer of the current neural network model and the first layer sensitivity of the quantization layer are inversely related.

In some implementations, the first layer sensitivity of the quantization layer may be determined based on a range of inverse quantization weights of each layer subsequent to the quantization layer in the current neural network model. For example, the first layer sensitivity of the quantization layer in the current neural network model may be a product of a range of the inverse quantization weights of each layer subsequent to the quantization layer in the current neural network model.

In some implementations, the inverse quantization weights of each layer subsequent to the quantization layer in the current neural network model are based on values of weights after the quantization, of each layer subsequent to the quantization layer in the current neural network model. That is, the inverse quantization weights of each layer subsequent to the quantization layer in the current neural network model are based on weights of a layer in the second neural network model corresponding to each layer subsequent to the quantization layer in the current neural network model. For example, the inverse quantization weights of a certain layer in the current neural network model may be the weights of the layer, corresponding to the certain layer, in the second neural network model. In an example, inverse quantization weights of a kth layer in the current neural network model may be weights of a kth layer in the second neural network model.

In an example, the first layer sensitivity of the quantization layer may be calculated by the following Equation (2).

$$IQN ( k ) = \frac{{\prod }_{i = k + 1}^{N} range ( {w}_{dq , i} )}{{\prod }_{i = 0}^{N} range ( {w}_{dq , i} )} \qquad Equation ( 2 )$$

In Equation (2), IQN(k) may denote the a layer sensitivity of a kth layer as a quantization layer in the current neural network model, N may denote a number of a plurality of layers in the current neural network model, w_{dq,i} may denote inverse quantization weights of an ith layer in the current neural network model, and range(w_{dq,i}) may denote a range of the inverse quantization weights for the ith layer in the current neural network model. In an example, the distance of the quantization layer in the current neural network model from the input layer of the current neural network model may represent the number of layers between the quantization layer and the input layer.

However, examples are not limited thereto, the first layer sensitivity of the quantization layer in the current neural network model may be also calculated using other ways based on the range of the inverse quantization weights of each layer subsequent to the quantization layer in the current neural network model.

In an example, a first layer sensitivity of each layer in the second neural network model may be calculated after the second neural network model is obtained by quantizing a first neural network model. For example, for each layer in the second neural network model, a product of a range of weights of each layer subsequent to the layer may be determined as a first layer sensitivity of the layer in the second neural network model. For example, a product of a range of weights of each layer subsequent to a kth layer in the second neural network model may be determined as a first layer sensitivity of the kth layer in the second neural network model.

In this case, a first layer sensitivity of a quantization layer in the current neural network model may be determined as a first layer sensitivity of a layer, corresponding to the quantization layer, in the second neural network model.

In step S220, an input noise-to-signal ratio of the quantization layer in the current neural network model may be determined based on an original input and a quantization input of the quantization layer in the current neural network model.

In an example, the original input of the quantization layer in the current neural network model may represent an input of a layer, corresponding to the quantization layer, in the first neural network model obtained by executing the first neural network model, and the quantization input of the quantization layer in the current neural network model represents an input of the quantization layer obtained by executing the current neural network model.

In this case, input data for executing the current neural network model may be the same as input data for executing the first neural network model, and may be predetermined multimedia data.

In an example, the input noise-to-signal ratio of the quantization layer may be calculated by the following Equation (3).

$$NSR ( kx ) = ( \frac{{\sum }_{i = 1}^{M} {( {x}_{noise , i} )}^{2}}{{\sum }_{i = 1}^{M} ( {x}_{i}^{2} )} ) \qquad Equation ( 3 )$$

In Equation (3), NSR(kx) may denote an input noise-to-signal ratio of a kth layer as a quantization layer in the current neural network model, M may denote a number of data in an input of the kth layer in the current neural network model, x_{noise,i} may denote quantization noise of ith data in the input of the kth layer in the current neural network model, and xᵢ may denote data, corresponding to the ith data, in an input of a kth layer in the first neural network model.

In an example, the input of the kth layer in the current neural network model may include (e.g., in the case of executing the current neural network model with predetermined input data) a plurality of data input to a plurality of nodes of the kth layer in the current neural network model. In an example, at least one data may be input to each node of the kth layer in the current neural network model.

In an example, an input of the kth layer in the first neural network model may include (e.g., in the case of executing the first neural network model with the predetermined input data) a plurality of data input to a plurality of nodes of the kth layer in the first neural network model.

In an example, the quantization noise of the ith data in the input of the kth layer in the current neural network model may be a difference between the ith data and the data, corresponding to the ith data, in the input of the kth layer in the first neural network model.

In step S230, an output noise-to-signal ratio of the quantization layer in the current neural network model may be determined based on an original output and a quantization output of the quantization layer in the current neural network model.

In an example, the original output of the quantization layer in the current neural network model may represent an output of a layer, corresponding to the quantization layer, in the first neural network model obtained by executing the first neural network model, and the quantization output of the quantization layer in the current neural network model represents an output of the quantization layer obtained by executing the current neural network model.

In an example, the output noise-to-signal ratio of the quantization layer may be calculated by the following Equation (4).

$$NSR ( ky ) = ( \frac{{\sum }_{i = 1}^{L} {( {y}_{noise , i} )}^{2}}{{\sum }_{i = 1}^{L} ( {y}_{i}^{2} )} ) \qquad Equation ( 4 )$$

In Equation (4), NSR(ky) may denote an output noise-to-signal ratio of a kth layer as a quantization layer in the current neural network model, L may denote a number of data in an output of the kth layer in the current neural network model, y_{noise,i} may denote quantization noise of i-th data in the output of the kth layer in the current neural network model, and yᵢ may denote data, corresponding to the i-th data, in an output of a kth layer in the first neural network model.

In an example, the output of the kth layer in the current neural network model may include a plurality of data (e.g., activation values) output from a plurality of nodes of the kth layer in the current neural network model.

In an example, the output of the kth layer in the first neural network model may include a plurality of data (e.g., activation values) output from a plurality of nodes of the kth layer in the first neural network model.

In an example, the quantization noise of the ith data in the output of the kth layer of the current neural network model may be a difference between the ith data and “the data corresponding to the ith data, in the output of the kth layer in the first neural network model.”

For example, the quantization noise of the ith data (e.g., the activation value output by the ith node of the kth layer) in the output of the kth layer in the current neural network model may be a difference between the ith data output by the ith node of the kth layer in the current neural network model and data output by an ith node of the kth layer in the first neural network model.

However, examples are not limited thereto, and the input noise-to-signal ratio and the output noise-to-signal ratio of the quantization layer may be also calculated using other calculations based on the original input, the original output, the quantization input, and the quantization output of the quantization layer in the current neural network model.

In step S240, a rate of change in noise of the quantization layer in the current neural network model may be determined as the second layer sensitivity, based on the input noise-to-signal ratio and the output noise-to-signal ratio of the quantization layer in the current neural network model.

In an example, the rate of change in noise of the quantization layer may be calculated by the following Equation (5).

$$OINR ( k ) = {NSR ( ofm )}_{k} - {NSR ( ifm )}_{k} \qquad Equation ( 5 )$$

In Equation (5), OINR(k) may denote a rate of change in noise or a second layer sensitivity of a kth layer as a quantization layer in the current neural network model, NSR(ofm)ₖ may denote an output noise-to-signal ratio of the kth layer in the current neural network model, and NSR(ifm)ₖ may denote an input noise-to-signal ratio of the kth layer in the current neural network model. In an example, the input noise-to-signal ratio of the kth layer in the current neural network model may be represented as an output noise-to-signal ratio of a (k−1)th layer in the current neural network model.

However, examples are not limited thereto, and the second layer sensitivity may be also calculated using other calculations based on the input noise-to-signal ratio and the output noise-to-signal ratio.

In step S250, a layer sensitivity of the quantization layer may be determined based on the first layer sensitivity and the second layer sensitivity of the quantization layer.

For example, the layer sensitivity of the quantization layer may be determined based on a sum of the first layer sensitivity and the second layer sensitivity of the quantization layer.

However, examples are not limited thereto, and the layer sensitivity of the quantization layer may be also calculated using other calculations based on the first layer sensitivity and the second layer sensitivity of the quantization layer. In an example, the layer sensitivity of the quantization layer may be calculated based only on the second layer sensitivity of the quantization layer without considering the first layer sensitivity of the quantization layer.

In the present application, by determining the layer sensitivity using the first layer sensitivity that reflects influence of the position of the layer and the second layer sensitivity that reflects influence of quantization noise on each layer, the sensitivity of the layer with respect to the quantization can be more effectively measured and a decrease in the precision of the neural network model due to quantization of layers having high sensitivities can be avoided, to select a configuration of suitable mixed precision quantization.

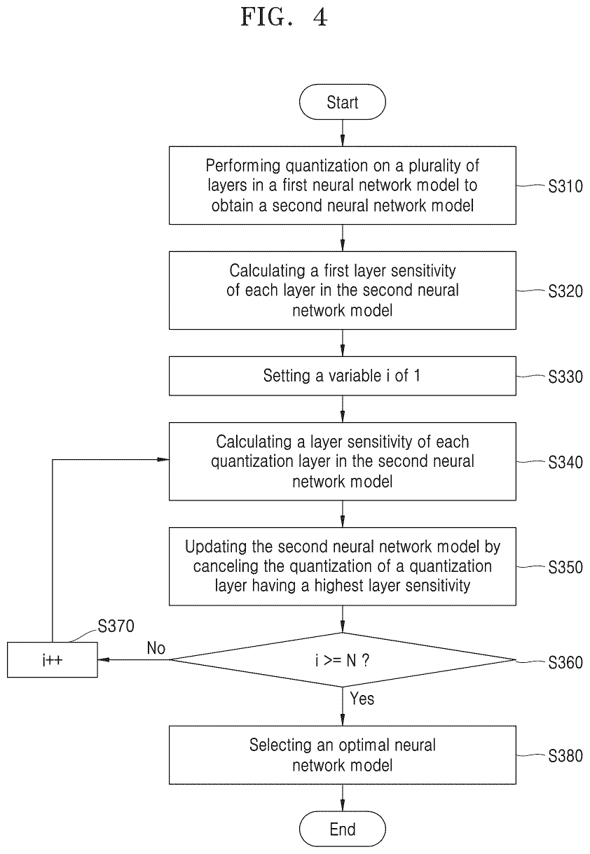

FIG. 4 is a flowchart illustrating an example of a quantization method of a neural network model.

As shown in FIG. 4, in step S310, quantization may be performed on a plurality of layers in a first neural network model to obtain a second neural network model.

In step S320, a first layer sensitivity of each layer in the second neural network model may be calculated. The processing of calculating the first layer sensitivity was described in detail above with reference to FIG. 3, and thus, its detailed description will be omitted herein to avoid redundancy.

In step S330, a variable i may be set to an initial value of 1.

In step S340, a layer sensitivity of each quantization layer in the second neural network model may be calculated. For example, a layer sensitivity of each quantization layer in a current neural network model may be calculated using the initial second neural network model as the current neural network model.

In step S350, the second neural network model may be updated by canceling the quantization of a quantization layer having a highest layer sensitivity, to obtain and output a third neural network model.

For example, assuming that the first neural network model may be represented as the DNN 10 shown in FIG. 1, the first neural network model may include a plurality of layers L1, L2, L3 . . . LN, the second neural network model may include a plurality of layers L1′, L2′, L3′ . . . LN′ obtained by quantizing the plurality of layers L1, L2, L3 . . . LN, and a kth layer LK′ among the plurality of layers L1′, L2′, L3′ . . . LN′ of the second neural network model has a highest layer sensitivity, then in step S350, the second neural network model may be updated by canceling the quantization of the Kth layer LK′, and the updated second neural network model is output as the third neural network model (including a plurality of layers L1′, L2′, L3′ . . . LK−1′, LK, LK+1′ . . . LN′).

In step S360, it may be determined whether the variable i is greater than or equal to N. For example, N may denote a number of the plurality of layers in the first neural network model.

If the variable i is less than N, in step S370, the variable i may be increased by 1, and steps S340 through S360 may be repeated.

For example, a layer sensitivity of each quantization layer in the current neural network model may be calculated using the updated second neural network model as the current neural network model, and the second neural network model may continue to be updated to output the newly updated second neural network model as a new third neural network model. For example, the updated second neural network model that includes the plurality of layers L1′, L2′, L3′ . . . LK−1′, LK, LK+1′ . . . LN′ may be used to determine a layers having a highest layer sensitivity among the plurality of layers L1′, L2′, L3′ . . . LK−1′, LK+1′ . . . LN′, and the second neural network model continues to be updated by canceling the quantization of the layer having the highest layer sensitivity.

When the variable i is greater than or equal to N, in step S380, an optimal neural network model may be selected from among the output N third neural network models.

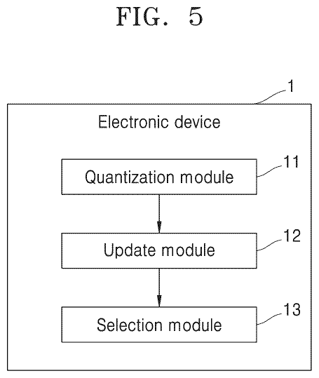

FIG. 5 is a block diagram illustrating an example of an electronic device.

For example, the electronic device can include a desktop computer, a laptop computer, a tablet computer, a server system, and the like. However, the present disclosure is not limited thereto, and the electronic device may be any electronic device having functions for processing multimedia data.

As shown in FIG. 5, an electronic device 1 may include a quantization module 11, an update module 12, and a selection module 13.

In some implementations, the quantization module 11 may perform quantization on a plurality of layers in a first neural network model, to obtain a second neural network model.

In some implementations, the first neural network model may be a high-precision model and the second neural network model may be a low-precision model. For example, each layer (e.g., weights of each layer) in the first neural network model may have a first bitwidth, each layer in the second neural network model may have a second bitwidth, and the first bitwidth may be greater than the second bitwidth.

In some implementations, the update module 12 may calculate, using the second neural network model as a current neural network model, a layer sensitivity of each layer of layers, on which the quantization has been performed, in the current neural network model.

The processing of determining the layer sensitivity was described in detail above with reference to FIG. 3, and thus, its detailed description will be omitted herein to avoid redundancy.

In some implementations, the update module 12 may update the current neural network model by canceling the quantization of a layer having a highest layer sensitivity among the layers on which the quantization has been performed, to obtain a third neural network model.

In some implementations, a greedy search algorithm may be used to search for the layer having the highest layer sensitivity from among the layers on which the quantization has been performed to improve the efficiency of searching.

In some implementations, the quantization of the layer having the highest layer sensitivity may be canceled by setting weights of the layer having the highest layer sensitivity to weights, previous to the quantization, of the layer having the highest layer sensitivity.

In some implementations, the update module 12 may calculate, using the third neural network model as the current neural network model, a layer sensitivity of each layer of layers, on which the quantization has been performed, in the current neural network model.

In some implementations, the update module 12 may repeat the updating of the current neural network model and the calculating of the layer sensitivity, until a predetermined number of third neural network models are obtained.

In some implementations, the predetermined number may be equal to a number of the plurality of layers in the first neural network model. In other words, the updating of the current neural network model and the calculating of the layer sensitivity may be repeated until all layers, on which the quantization has been performed, in the second neural network model are recovered.

In some implementations, the selection module 13 may select an optimal neural network model from among the predetermined number of third neural network models.

The processing of selecting the optimal neural network model was described in detail above with reference to FIG. 2, and thus, its detailed description will be omitted herein to avoid redundancy.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples plurality of processors or computers may be used, or a processor or computer may include plurality of processing elements, or plurality of types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction plurality of-data (SIMD) multiprocessing, plurality of-instruction single-data (MISD) multiprocessing, and plurality of-instruction plurality of-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software include machine code that is directly executed by the processor or computer, such as machine code produced by a compiler. In another example, the instructions or software include higher-level code that is executed by the processor or computer using an interpreter. Programmers of ordinary skill in the art may readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

While this disclosure includes specific examples, it will be apparent to one of ordinary skill in the art that various changes in form and details may be made in these examples without departing from the spirit and scope of the claims and their equivalents.

What is claimed is:

1. A quantization method of a neural network model for processing multimedia data comprising:
(i) performing quantization on a plurality of layers in a first neural network model to obtain a second neural network model;
(ii) calculating, using the second neural network model as a current neural network model, a layer sensitivity of each layer of the plurality of layers;
(iii) updating the current neural network model by canceling the quantization of a layer, among layers on which the quantization has been performed in the current neural network model, that has a highest layer sensitivity to obtain a third neural network model;
(iv) calculating, using the third neural network model as the current neural network model, a layer sensitivity of each layer of layers on which the quantization has been performed in the current neural network model;
(v) repeating (iii) and (iv) until a predetermined number of third neural network models are obtained; and
(vi) selecting an optimal neural network model from among the predetermined number of third neural network models.

2. The quantization method of claim 1, wherein canceling the quantization of the layer that has the highest layer sensitivity comprises: setting weights of the layer that has the highest layer sensitivity to the weights that the layer that has the highest layer sensitivity had prior to the quantization, and
wherein the predetermined number is a number of the plurality of layers.

3. The quantization method of claim 1, wherein calculating, using the second neural network model as the current neural network model, the layer sensitivity of each layer of the plurality of layers, comprises:
determining a first layer sensitivity of a respective layer based on a position of the respective layer in the current neural network model;
determining a second layer sensitivity of the respective layer based on a rate of change in noise of the respective layer; and
determining the layer sensitivity of the respective layer based on the first layer sensitivity and the second layer sensitivity.

4. The quantization method of claim 3, wherein determining the second layer sensitivity of the respective layer comprises:
determining an input noise-to-signal ratio of the respective layer based on an original input and a quantization input of the respective layer;
determining an output noise-to-signal ratio of the respective layer based on an original output and a quantization output of the respective layer; and
determining the rate of change in noise of the respective layer, based on the input noise-to-signal ratio and the output noise-to-signal ratio of the respective layer,
wherein the original input of the respective layer represents an input of a corresponding layer that corresponds to the respective layer of the first neural network model obtained by executing the first neural network model, and the quantization input of the respective layer represents an input of the respective layer obtained by executing the current neural network model, and
wherein the original output of the respective layer represents an output of the corresponding layer that corresponds to the respective layer of the first neural network model obtained by executing the first neural network model, and the quantization output of the respective layer represents an output of the respective layer obtained by executing the current neural network model.

5. The quantization method of claim 3, wherein a distance of the respective layer from an input layer of the current neural network model and the first layer sensitivity of the respective layer are inversely related,
wherein the first layer sensitivity of the respective layer is determined based on a range of inverse quantization weights of each layer subsequent to the respective layer in the current neural network model, and
wherein the inverse quantization weights of each layer subsequent to the respective layer in the current neural network model are based on weights, after the quantization, of each layer subsequent to the respective layer in the current neural network model.

6. The quantization method of claim 1, wherein selecting the optimal neural network model comprises:
calculating, based on a rate of change in noise of an output layer of each of the predetermined number of third neural network models and a size of each of the predetermined number of third neural network models, a loss associated with each of the predetermined number of third neural network models; and
selecting a neural network model having a smallest loss from among the predetermined number of third neural network models.

7. The quantization method of claim 6, wherein selecting the optimal neural network model comprises determining, based on a sum of bitwidths of weights of a plurality of layers of each of the predetermined number of third neural network models, the size of each of the predetermined number of third neural network models.

8. An electronic device comprising:
a quantization module configured to perform quantization on a plurality of layers in a first neural network model to obtain a second neural network model;
an updating module configured to:
(i) calculate, using the second neural network model as a current neural network model, a layer sensitivity of each layer of the plurality of layers,
(ii) update the current neural network model by canceling the quantization of a layer, among layers on which the quantization has been performed in the current neural network model, that has a highest layer sensitivity to obtain a third neural network model,
(iii) calculate, using the third neural network model as the current neural network model, a layer sensitivity of each layer of layers on which the quantization has been performed in the current neural network model and
(iv) repeat (ii) and (iii) until a predetermined number of third neural network models are obtained; and
a selection module configured to select an optimal neural network model from among the predetermined number of third neural network models.

9. The electronic device of claim 8, wherein the updating module is configured to cancel the quantization of the layer that has the highest layer sensitivity by setting the weights of the layer that has the highest layer sensitivity to the weights prior to the quantization, and
wherein the predetermined number is equal to a number of the plurality of layers.

10. The electronic device of claim 8, wherein the updating module is configured to calculate the layer sensitivity of a respective layer of the plurality of layers by:
determining a first layer sensitivity of the respective layer based on a position of the respective layer in the current neural network model;
determining a second layer sensitivity of the respective layer based on a rate of change in noise of the respective layer; and
determining the layer sensitivity of the respective layer based on the first layer sensitivity and the second layer sensitivity.

11. The electronic device of claim 10, wherein the updating module is configured to:
determine an input noise-to-signal ratio of the respective layer based on an original input and a quantization input of the respective layer;
determine an output noise-to-signal ratio of the respective layer based on an original output and a quantization output of the respective layer; and
determine the rate of change in noise of the respective layer, based on the input noise-to-signal ratio and the output noise-to-signal ratio of the respective layer,
wherein the original input of the respective layer represents an input of a corresponding layer, corresponding to the respective layer, of the first neural network model obtained by executing the first neural network model, and the quantization input of the respective layer represents an input of the respective layer obtained by executing the current neural network model, and
wherein the original output of the respective layer represents an output of the corresponding layer, corresponding to the respective layer, of the first neural network model obtained by executing the first neural network model, and the quantization output of the respective layer represents an output of the respective layer obtained by executing the current neural network model.

12. The electronic device of claim 10, wherein a distance of the respective layer from an input layer of the current neural network model and the first layer sensitivity of the respective layer are inversely related,
wherein the first layer sensitivity of the respective layer is determined based on a range of inverse quantization weights of each layer subsequent to the respective layer in the current neural network model, and
wherein the inverse quantization weights of each layer subsequent to the respective layer in the current neural network model are based on weights, after the quantization, of each layer subsequent to the respective layer in the current neural network model.

13. The electronic device of claim 8, wherein the selection module is configured to:
calculate a loss associated with each of the predetermined number of third neural network models, based on a rate of change in noise of an output layer of each of the predetermined number of third neural network models and a size of each of the predetermined number of third neural network models; and
select a neural network model having a smallest loss from among the predetermined number of third neural network models.

14. The electronic device of claim 13, wherein the selection module is configured to:
determine the size of each of the predetermined number of third neural network models, based on a sum of bitwidths of weights of a plurality of layers of each of the predetermined number of third neural network models.

15. A computer-readable storage medium storing a computer program that, when executed by a processor, cause a processor to execute the following operations:
(i) performing quantization on a plurality of layers in a first neural network model to obtain a second neural network model;
(ii) calculating, using the second neural network model as a current neural network model, a layer sensitivity of each layer of the plurality of layers;
(iii) updating the current neural network model by canceling the quantization of a layer, among layers on which the quantization has been performed in the current neural network model, that has a highest layer sensitivity to obtain a third neural network model;
(iv) calculating, using the third neural network model as the current neural network model, a layer sensitivity of each layer of layers on which the quantization has been performed in the current neural network model;
(v) repeating (iii) and (iv) until a predetermined number of third neural network models are obtained; and
(vi) selecting an optimal neural network model from among the predetermined number of third neural network models.

16. The computer-readable storage medium of claim 15, wherein canceling the quantization of the layer that has the highest layer sensitivity comprises: setting weights of a layer that has the highest layer sensitivity to the weights that the layer that has the highest layer sensitivity had prior to the quantization,
wherein the predetermined number is a number of the plurality of layers.

17. The computer-readable storage medium of claim 15, wherein calculating, using the second neural network model as the current neural network model, the layer sensitivity of each layer of the plurality of layers comprises:
determining a first layer sensitivity of a respective layer based on a position of the respective layer in the current neural network model;
determining a second layer sensitivity of the respective layer based on a rate of change in noise of the respective layer; and
determining the layer sensitivity of the respective layer based on the first layer sensitivity and the second layer sensitivity.

18. The computer-readable storage medium of claim 17, wherein determining the second layer sensitivity of the respective layer comprises:
determining an input noise-to-signal ratio of the respective layer based on an original input and a quantization input of the respective layer;
determining an output noise-to-signal ratio of the respective layer based on an original output and a quantization output of the respective layer; and
determining the rate of change in noise of the respective layer, based on the input noise-to-signal ratio and the output noise-to-signal ratio of the respective layer,
wherein the original input of the respective layer represents an input of a corresponding layer that corresponds to the respective layer of the first neural network model obtained by executing the first neural network model, and the quantization input of the respective layer represents an input of the respective layer obtained by executing the current neural network model, and
wherein the original output of the respective layer represents an output of the corresponding layer that corresponds to the respective layer of the first neural network model obtained by executing the first neural network model, and the quantization output of the respective layer represents an output of the respective layer obtained by executing the current neural network model.

19. The computer-readable storage medium of claim 15, wherein selecting the optimal neural network model comprises:
calculating, based on a rate of change in noise of an output layer of each of the predetermined number of third neural network models and a size of each of the predetermined number of third neural network models, a loss associated with each of the predetermined number of third neural network models; and
selecting a neural network model having a smallest loss from among the predetermined number of third neural network models.

20. The computer-readable storage medium of claim 19, wherein selecting the optimal neural network model comprises determining, based on a sum of bitwidths of weights of a plurality of layers of each of the predetermined number of third neural network models, the size of each of the predetermined number of third neural network models.
